(19) United States
(12) Patent Application Publication
(10) Pub. No.: US 2023/0395933 A1
(43) Pub. Date: Dec. 7, 2023

(54) ADAPTABLE SAFETY DEVICE ON AN ELECTROCHEMICAL CELL

(71) Applicant: COMMISSARIAT À L'ENERGIE ATOMIQUE ET AUX ENERGIES ALTERNATIVES, Paris (FR)

(72) Inventors: Rémi VINCENT, Grenoble Cedex 09 (FR); Nicolas FERRIER, Grenoble Cedex 09 (FR)

(73) Assignee: COMMISSARIAT À L'ENERGIE ATOMIQUE ET AUX ENERGIES ALTERNATIVES, Paris (FR)

(21) Appl. No.: 18/250,908

(22) PCT Filed: Oct. 26, 2021
(86) PCT No.: PCT/EP2021/079638

§ 371 Date: Apr. 27, 2023

(30) Foreign Application Priority Data
Oct. 29, 2020 (FR) 20 11101

(51) Int. Cl. H01M 50/342; H01M 50/107; H01M 10/04

(52) U.S. Cl. CPC H01M 50/3425; H01M 50/107; H01M 10/0431

(57) ABSTRACT

A safety device adapted to an electrochemical cell, the cell having a container in which a coil is placed, the container including at least one first wall provided with at least one rupture initiator, designed to break in the event of a fault so as to expel the gases, and a second wall arranged to ensure the coil is held in said container, the safety device has a holding device arranged to ensure an abutment against said second wall of the cell so as to hold it in position in the event of thermal runaway and to retain the coil on the inside of the container, a gas releasing device, arranged to ensure the expulsion of the gases from the cell, in the event of thermal runaway.

### TECHNICAL FIELD OF THE INVENTION

The present invention relates to a safety device which can be adapted to an electrochemical cell, for example a battery of cylindrical format.

### PRIOR ART

At present, the most commonly used electrochemical lithium cell is best known by the reference 18650. Such a cell is described, for example, in U.S. Pat. No. 8,323,825B2. Recently, cells of the 21700 standard have also been proposed.

These cells of 18650, 21700 type or other cylindrical formats have a cylindrical container, referred to as cup, in which a roll, also referred to as coil, that brings the two electrodes together is placed. An electrolyte is then injected into said cup. The cup is closed at its lower end and open at its upper end, a cap being attached to this upper end to hermetically close the container.

Such a lithium cell is leaktight and generally has protection devices borne by its cap in order to prevent it from exploding in the event of inappropriate use (in terms of temperature or charge). These protection devices are notably the following:
A current interruption device (CiD) which interrupts the current in the event of overpressure in the cup, without affecting this pressure;
An overpressure vent which is generally produced in the form of a rupture disk which makes it possible to release the gases in order to prevent an explosion;
Lastly, the cup itself can also be weakened so that it opens in optimum conditions to prevent a more violent explosion.

The overpressure vent is generally set to break at a value of 15 to 20 bar and is often located on the positive pole side of the cell. In cells of the 21700 type, to improve safety, certain manufacturers add an additional overpressure vent on the opposite side to that bearing the main vent, that is to say on the negative pole (publication: Darcy et al.—2018—“Design Guidelines for Safe High Performing Li-ion Batteries with 18650 cells”). Certain cylindrical cell architectures that do not have a vent on the positive pole do, however, have a vent on the negative pole.

In the event of strong thermal runaway in a system, what can happen is that the kinetics of the reactions causes the cell to explode in spite of the presence of an overpressure vent, which makes the positive pole tear off from the cell and can cause the coil to be expelled from the cell. The expulsion can notably take place after the container tears at its mechanically most fragile wall.

Moreover, even though it is possible for the coil to be expelled only to half of its extent and/or sprayed over the neighboring cells, safety risks can thus appear. Direct contact of the electrolyte/coil with the neighboring cells causes the latter to heat up. The expulsion of the coil can then cause runaway in the neighboring cells.

The aim of the invention is to propose a safety device which can be adapted to an electrochemical cell and makes it possible to avoid the expulsion of the coil from the cell in the event of thermal runaway, whilst still making it possible to ensure the gases are released.

### DESCRIPTION OF THE INVENTION

This aim is achieved by a safety device which can be adapted to an electrochemical cell, said cell having a container in which a coil is placed, said container comprising a first wall provided with at least one rupture initiator, designed to break in the event of a fault so as to expel the gases, and a second wall preventing the coil from exiting said container, said safety device having:
A holding device arranged to ensure an abutment against said second wall of the container so as to hold it in position in the event of thermal runaway and to retain the coil on the inside of said container,
A gas releasing device, arranged to ensure the expulsion of the gases from the cell in the event of thermal runaway.

According to one particular feature, the holding device has a frame which is fixed in relation to the cell and abutment means fixed to said frame.

According to a first particular embodiment:
The gas releasing device has a plate, referred to as sealing plate, which has a through-hole,
The holding device has an abutment pad received in said hole in the sealing plate and configured to abut said second wall of the container, a channel being formed between said pad and the internal wall of said hole so as to form a passage for the gases,
The gas releasing device has closing off means arranged in said channel so as to close off said passage.

According to a particular feature, the closing off means have a lip seal.

According to another particular feature, the holding device has multiple abutment pads formed on one and the same common abutment plate fixed to said frame.

According to another particular feature, said abutment plate has at least one through-opening.

According to a second particular embodiment:
The holding device has an abutment plate arranged to ensure an abutment against said second wall of the cell, and a compression plate fixed to the frame and arranged to compress said abutment plate, said abutment plate comprising a first through-hole and said compression plate comprising a second through-hole,
The gas releasing device has a perforable film arranged between said abutment plate and said compression plate, forming closing off means for the passage created by the first through-hole and by the second through-hole.

According to one particular feature, the abutment plate has a recess for receiving a metal foil.

According to another particular feature, said abutment plate has a receiving compartment for an electrochemical cell.

According to a particular aspect of the invention, the frame has a casing intended to accommodate said electrochemical cell.

The invention also relates to the use of the safety device as defined above and intended for adaptation to an electrochemical cell of cylindrical format.

According to one particular feature, the electrochemical cell is of the 18650 or 21700 format.

The solution of the invention makes it possible to place the positive pole under stress/pressure whilst still making it possible for the gas to escape in the event of thermal runaway.

### BRIEF DESCRIPTION OF THE FIGURES

Further features and advantages will become apparent from the following detailed description, given with reference to the appended drawings, in which:

FIG. 1A shows a schematic view, in section, of a lithium cell of the 18650 or 21700 type;

FIG. 1B shows the cell of FIG. 1A, on which the main forces exerted on the walls of the container in the event of thermal runaway are depicted;

FIGS. 2A and 2B show perspective views of a current interrupter device and a vent, respectively, that are conventionally used in a lithium battery as shown in FIG. 1;

FIG. 3 illustrates a top view of the principle for producing a pack of multiple electrochemical cells in a staggered arrangement;

FIGS. 4A and 4B show a first embodiment of the device of the invention, adapted for an electrochemical cell;

FIGS. 5A and 5B show a second embodiment of the device of the invention, adapted for an electrochemical cell;

FIG. 6 illustrates the adaptation of the first embodiment to a pack of multiple cells;

FIG. 7 illustrates the adaptation of the second embodiment to a pack of multiple cells;

FIG. 8 shows an embodiment variant of the architecture of FIG. 7;

FIG. 9 shows a third embodiment of the device of the invention;

FIG. 10 illustrates the adaptation of the third embodiment to a pack of multiple cells.

### DETAILED DESCRIPTION OF AT LEAST ONE EMBODIMENT

The invention mainly aims to propose a solution for avoiding the expulsion of the coil in the event of thermal runaway in the cell.

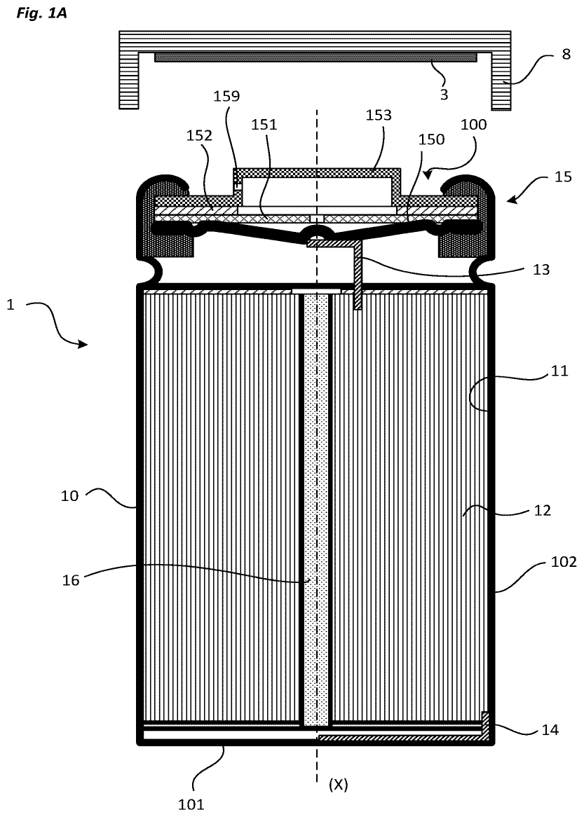

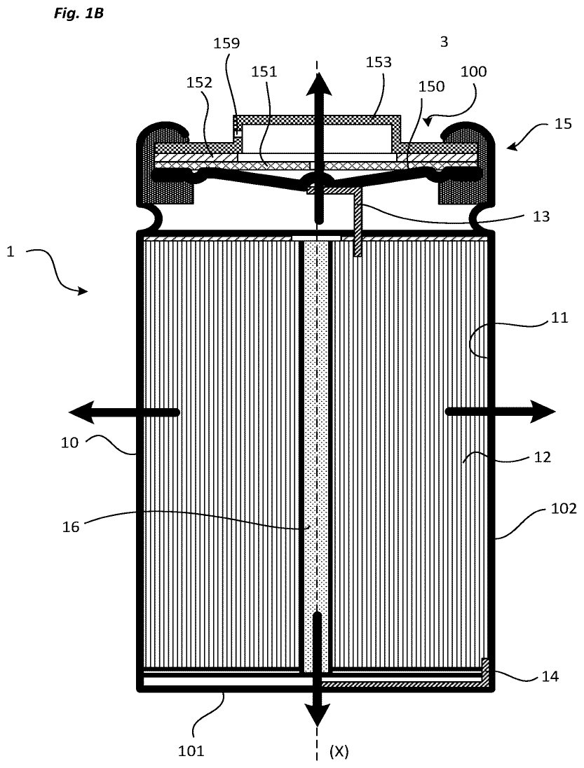

In the remainder of the description, the terms “top”, “bottom”, “lower”, “upper”, “above” and “below” should be understood with reference to the vertical axis (X) shown in FIG. 1.

The safety device of the invention is notably perfect for adaptation to a secondary electrochemical lithium cell.

The safety device of the invention is described mainly for a cell in the form of a cylinder of revolution, for example of the 18650 or 21700 type, but it is necessary to understand that it can be adapted to a cell having a different external shape, notably of prismatic type, its principle being reproducible irrespective of the shape of the cell.

With reference to FIG. 1A, a conventional secondary lithium cell of the 18650 or 21700 type has a cylindrical shape with a circular base, developed around the axis (X). Such a cell is described, for example, in U.S. Pat. No. 8,323,825B2.

Nonlimitingly, such a lithium cell 1 mainly has a container having an upper head comprising an upper wall 100 bearing the positive pole, a lower head comprising a lower wall 101 bearing the negative pole, and a lateral wall 102. The container is generally composed of a cylindrical cup 10 and a cap 15 that is fixed to the cup and closes the latter over its upper part. This cup 10 defines an internal volume 11 in which the two electrodes 12 (shown by a single assembly in FIG. 1) are placed. The two electrodes 12 are produced on either side of a flexible insulating plate that has been rolled up to form a cylindrical assembly which is received in the cup 10 and forms a coil. An electrolyte is then injected into the internal volume 11 of the cup. A central insert 16 can be inserted axially into the cup 10. The cell has two connection pads 13, 14 each connected to a distinct electrode. Over its upper part, the cup 10 is hermetically closed by a cap 15. This cap 15 bears a stack located on the inside of the cup 10 and formed by an overpressure vent 150, a current interrupter device 151, possibly a thermistor 152 of the PTC (positive temperature coefficient) type, and an external cap 153 forming a first electrical terminal for connection of the cell.

The current interrupter device 151 is actuated by the vent 150 when the pressure of the gases present inside the cup 10 becomes too great. In this excessive pressure situation, the vent 150 deforms until the current interrupter device 151 located above it breaks, then causing the interruption of the electrical current supplied. If the pressure of the gases present inside the cup continues to increase, the vent 150 can deform until it breaks, so as to enable the release of the gases toward the outside.

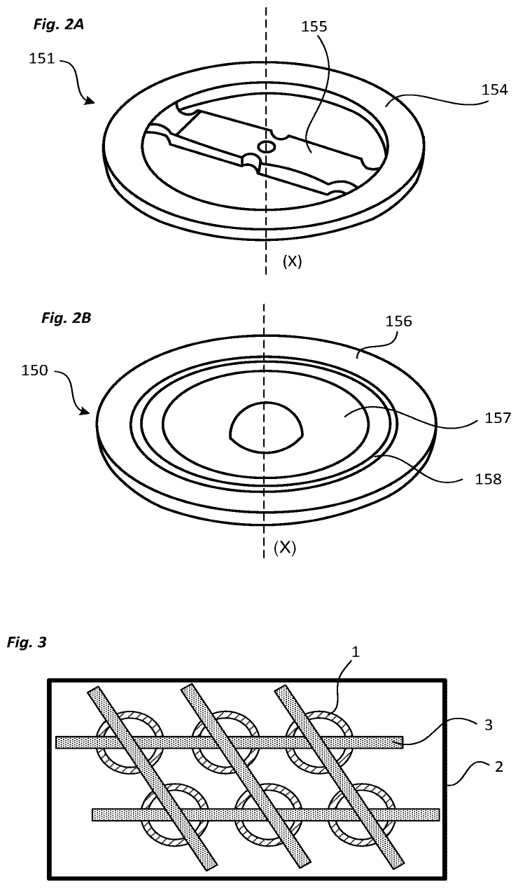

With reference to FIG. 2A and nonlimitingly, the current interruption device 151 may take the form of a ring 154 which is coaxial with the axis (X) and comprises a diametric bridge 155 through which the electric current circulates. This bridge 155 is capable of breaking when the pressure in the cup exceeds a certain threshold, with the electric current in the cell then being interrupted.

As shown in FIG. 2B and nonlimitingly, the vent may take the form of a disk 156 which is coaxial with the axis (X) and has a curved profile 157 forming a concavity toward the inside of the cell. Under the effect of the pressure, this curved profile deforms so as to form a profile which is convex toward the outside, and when the pressure exceeds a certain threshold, the vent breaks under the effect of the pressure of the gases. The vent may have an annular furrow 158 forming a rupture initiator.

The main overpressure vent is generally placed on the positive pole side of the cell, on its upper part. Optionally, it may be replaced or supplemented by a vent placed on the negative pole side.

The safety device of the invention can be produced for adaptation to one or more electrochemical cells.

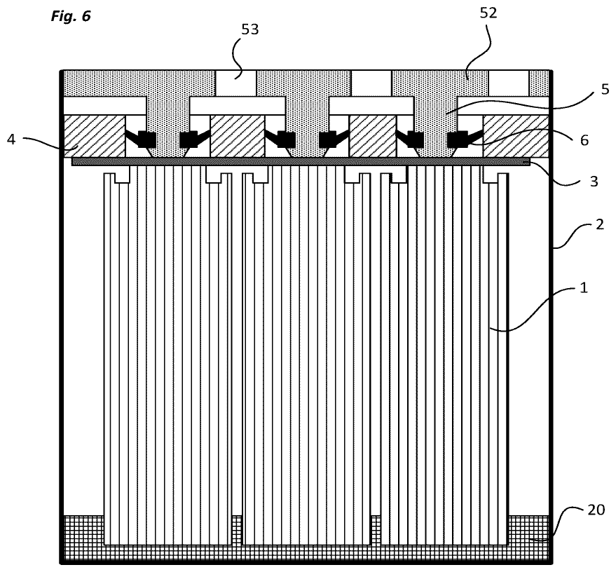

As shown in FIG. 3, multiple cells 1 can specifically be stored upright in a casing 2 and connected to one another, in series/parallel, by utilizing metal foils 3 for ensuring the connections, with the cells then forming a pack. The cells 1 can for example be stored in a staggered manner. Compartments or trays can be provided for holding the cells 1 in the casing 2, at their upper part and/or lower part (20, FIGS. 6 to 8).

On each cell 1, as shown in FIG. 1, a foil 3 is created in the form of a metal strip which comes into contact with the positive pole of the cell 1.

Nonlimitingly, the foil 3 may be borne by an end piece 8 designed to be positioned on the upper or lower head of the cell, on the positive pole side or the negative pole side, respectively, of the cell. When multiple cells are juxtaposed, these end pieces 8 can be joined together to form a single piece 502, forming said holding trays for the cells in the casing and acting as a spacer between the cells that are juxtaposed (FIG. 8).

According to a particular aspect of the invention, it should be noted that the safety device of the invention is intended to be permanently fixed to the cell.

FIG. 1B shows the forces exerted on the walls of the container of the cell 1 in the event of thermal runaway. It has been found that, in its upper part, the container has mechanical weaknesses, associated with the presence of the vent and then of the cap 153 forming the positive pole. The latter can notably have multiple radial openings 159 enabling the release of the gases. These openings, however, have a tendency to weaken its structure and its mechanical strength. The crimped joining of the cap 153 to the lateral wall 102 of the cell constitutes another fragile zone and deformation of the cap 153 is capable of causing this crimped connection to tear. In the event of rupture of the wall forming the positive pole, the expulsion of the coil from the container of the cell can then be assisted.

Generally, the safety device has a holding device intended to be fixed to the container and arranged so as to ensure the wall of the container is held in position, through which wall the coil would be most likely to be expelled in the event of thermal runaway. It may notably be a wall with certain mechanical fragilities.

The holding device is configured to ensure a mechanical abutment as close as possible to the axis (X) of revolution of the cell.

Conventionally and nonlimitingly, this wall has the cap 153 forming the positive pole of the cell 1. As indicated above, this cap 153 is placed in the path of the coil in the event of expulsion of the latter, and has certain mechanical fragilities.

The safety device also has a gas releasing device, arranged to ensure the expulsion of the gases from the cell in the event of thermal runaway.

Advantageously, the safety device is designed to be positioned on the upper head of the cell 1, bearing the positive pole.

However, in one embodiment variant, it will be seen that it is possible to position it on the lower head of the cell 1, if it has an overpressure vent on its negative pole side. The device of the invention will notably be useful on the negative pole in the event of mechanical weakness of the container on the negative pole side, it being possible for this mechanical weakness to cause it to rupture and the coil to be expelled in the event of thermal runaway in the cell 1.

The holding device has a frame 7 which is fixed in relation to the cell 1 and holding means fixed to said frame 7 and arranged to abut the wall of the container that is intended to hold the coil in the cell. It should be noted that this wall must be distinguished from that bearing the rupture initiator, the latter of course being configured to break in the event of thermal runaway in order to release the gases.

The gas releasing device has at least one channel arranged facing the rupture initiator and closing off means for this channel. The closing off means are configured to open, after the vent ruptures, under the pressure of the gases generated.

The safety device can incorporate said metal foil 3.

The safety device may be produced according to various distinct embodiments.

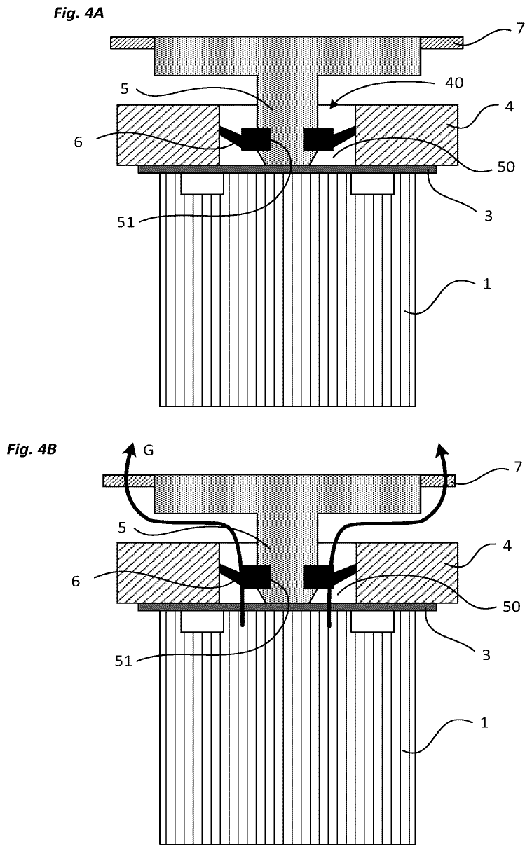

In a first embodiment shown in FIG. 4A and FIG. 4B, the gas releasing device may have a plate 4, referred to as sealing plate, that is fixed to the foil 3 transversely in relation to the axis (X), for example by adhesive bonding or screwing, and has a through-hole 40 forming a channel placed facing the rupture initiator of the overpressure vent.

The holding means have a holding member which is fixed to said frame 7 and has, for example, an abutment pad 5 received in the through-hole 40 of the sealing plate, with a channel, for example an annular channel 50, being formed between said pad 5 and the internal wall of said through-hole 40, this annular channel 50 forming a passage for the gases to be released in the event of thermal runaway.

The closing off means have a lip seal 6 of annular shape arranged in said channel 50 to close off said passage. Said seal 6 is configured to form a non-return valve and to allow the gases to be released only in one direction, from the cell 1 toward the outside, in the event of thermal runaway and to prevent any return of the gases from the outside back toward the cell and avoid propagation of the thermal runaway reaction to the neighboring cells. FIG. 4B shows the movement of the gases G in the event of thermal runaway.

The pad 5 may have an annular groove 51 on its lateral wall, in which said seal 6 is received.

By way of example, the abutment pad 5 may be made up of a plastics part or a screw, the body of which is received and screwed in the hole 40 in the plate 4. It should be noted that the sealing plate 4 is present to serve essentially as tightening support for the pad 5 so that the latter abuts the wall of the cup. The abutment pad 5 abuts the upper transverse wall of the cap 153 forming the positive pole of the cell 1.

When multiple cells 1 are juxtaposed upright in one and the same casing 2, the gas retaining and releasing devices may be shared. FIG. 6 illustrates this principle. The holding means can thus have a single abutment plate 52 supporting multiple pads 5 arranged in parallel, extending from one face of the plate 52, each pad 5 being dedicated to a distinct cell, for ensuring an abutment against the cap 153. Similarly, the sealing plate 4 is provided with multiple through-holes, in each of which a distinct pad 5 of the abutment plate 52 is received, a distinct lip seal 6 being positioned around each pad to ensure control of the gases.

Nonlimitingly, the abutment plate 52 may be fixed to the casing 2, by adhesive bonding or screwing, this joining making it possible to perform the holding function, the casing 2 performing the function of the frame 7. The abutment plate is advantageously equipped with multiple openings 53 to allow the gases to escape in the event of thermal runaway in one or more cells 1 placed in the casing 2. These holes are carefully sited to communicate with the gas outlet channels.

Similarly, the sealing plate 4 may be fixed, by adhesive bonding or screwing, to the foils 3. A sealing device of the seal or gel type may be incorporated between the sealing plate 4 and the internal wall of the casing 2 to avoid any return of gas back toward the cells.

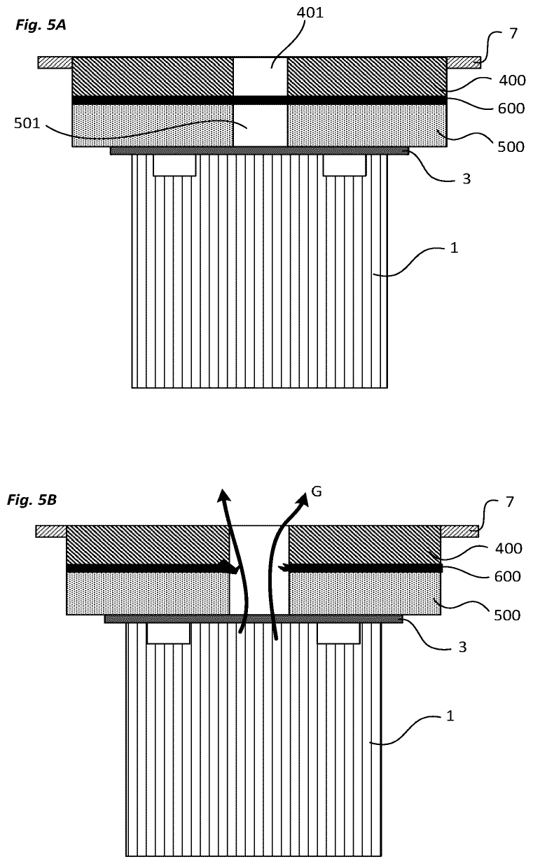

In a second embodiment shown in FIG. 5A and FIG. 5B, the holding means have an abutment plate 500 arranged transversely in relation to the axis (X) and fixed to the foil 3, and a compression plate 400 fixed to the frame 7 and arranged so as to compress said abutment plate 500. The bearing plate 500 is configured to at least partially abut the cap 153 forming the positive pole of the cell, with a view to being able to keep it in position in the event of thermal runaway in the cell 1.

The gas releasing device has a first through-hole 501 made through said bearing plate 500, and a second through-hole 401 which is made through said compression plate 400 and faces said first hole 501. The two holes form a passage arranged facing the rupture initiator. The closing off means have a perforable film 600, for example made of plastics material, which is placed between the two plates and configured to close off the passage formed by the two holes. The film 600 is configured to perforate when the gases are released, following the rupture of the rupture initiator. The through-hole 501 has a set diameter such that the abutment plate 500 is provided with a sufficiently large surface abutting the cap 153, making it possible to retain the coil in the event of thermal runaway whilst still ensuring the gases are released.

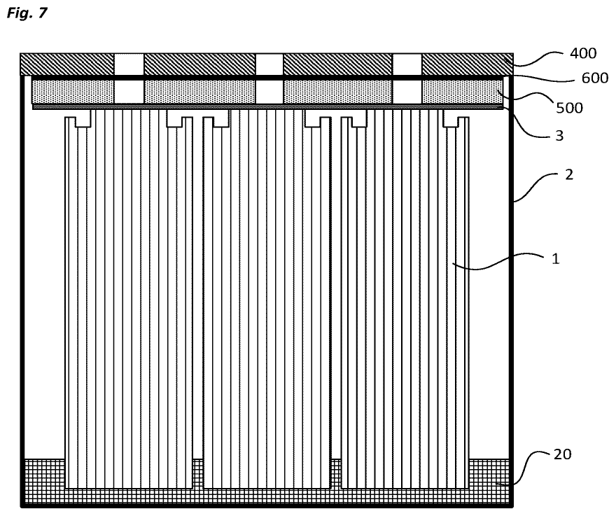

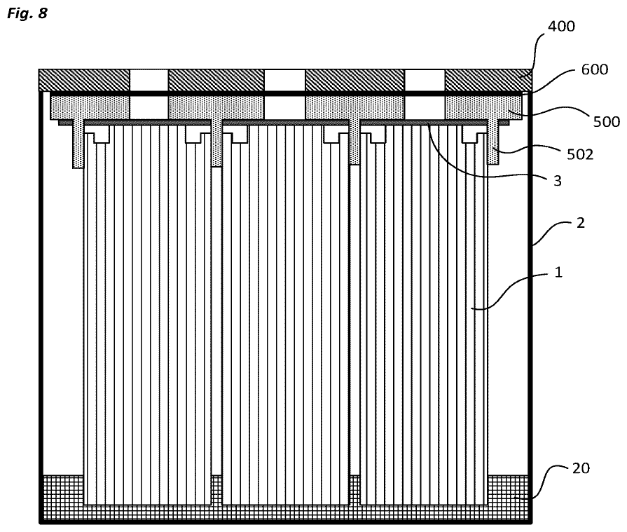

As in the first embodiment, the means may be shared when multiple cells 1 are brought together in a pack within one and the same casing 2, the latter performing the function of the frame 7. FIG. 7 illustrates this principle. The abutment plate 500, the film 600 and the compression plate 400 are thus joined together to form one and the same assembly, the film 600 compressed between the abutment plate and the compression plate ensuring leaktightness. This assembly may be produced by screwing the abutment plate to the compression plate. The compression plate 400 is fixed to the casing 2.

According to one embodiment variant, said abutment plate 500 may have compartments 502, the plate 500 thus performing the role of retaining the cells in the casing 2 and the role of the end piece 8 for supporting the foil 3. FIG. 8 illustrates this embodiment variant.

A third embodiment can be proposed for adaptation to the negative pole of the cell 1 when the latter has an overpressure vent on its negative pole side. This third embodiment is an offshoot of the second embodiment described above, applied to the negative pole of the cell 1. The references used are thus exactly as before.

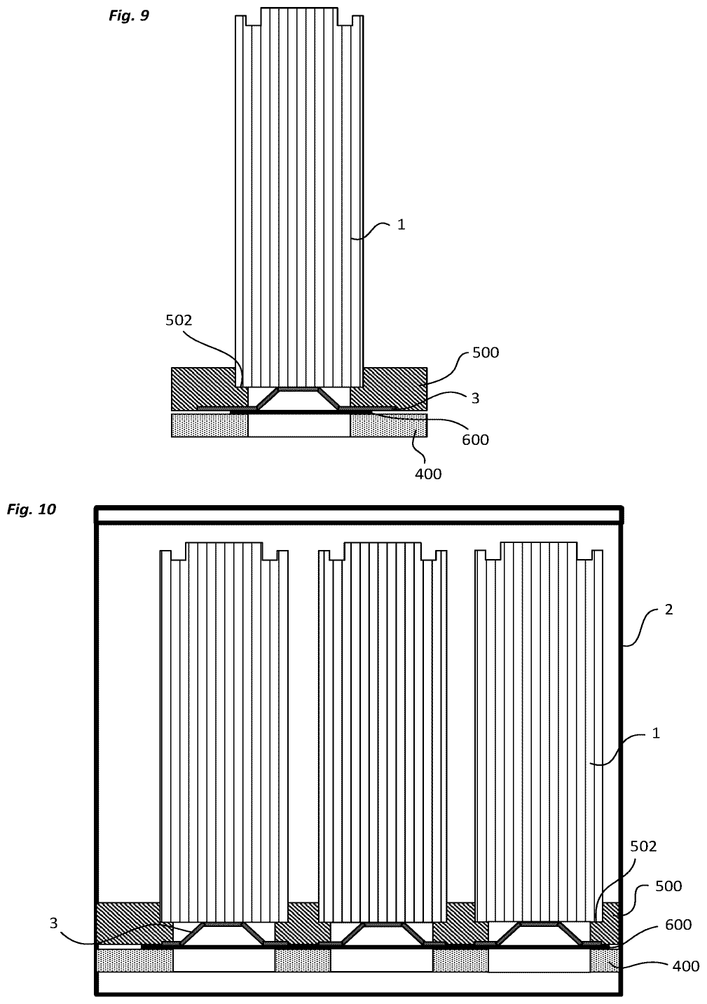

In this third embodiment illustrated by FIG. 9 and FIG. 10, the abutment plate 500 has a through-hole provided with an internal shoulder on which the lower head of the cell 1 rests, thus forming a holding compartment 502 for holding the cell on its lower part. A foil 3 for ensuring the electrical connection is received in said hole. The compression plate 400 is fixed to the abutment plate 500, the perforable film 600 being compressed between said compression plate and said abutment plate. The film 600 is configured to perforate when the gases are released, following the rupture of the rupture initiator of the vent. As illustrated in FIG. 10, this architecture can be duplicated for each cell 1 of a pack, with the bearing plate 500, the perforable film 600 and the compression plate 400 being shared by all of the cells 1 received in the casing 2. The abutment plate 500 thus has multiple compartments 502, each for accommodating the lower head of a distinct cell. The compression plate 400 may be fixed to the casing 2. A sealing device of the seal or gel type may be incorporated between the abutment plate 500 and the internal wall of the casing to avoid any return of gas back toward the cells 1.

It will be understood from the above text that the solution of the invention has numerous advantages, including:
It makes it possible to ensure the coil is retained in the cell, in the event of thermal runaway, whilst still conserving a solution for releasing the gases produced by the reaction;
It has a simple architecture;
It can be easily adapted to existing cells, individually or organized to form a pack in one and the same casing.

1. A safety device which can be adapted to an electrochemical cell, said cell having a container in which a coil is placed, said container comprising at least one first wall provided with at least one rupture initiator, designed to break in the event of a fault so as to expel the gases, and a second wall preventing the coil from exiting said container, wherein the safety device has:
a holding device arranged to ensure an abutment against said second wall of the container so as to hold it in position in the event of thermal runaway and to retain the coil on the inside of said container,
a gas releasing device, arranged to ensure the expulsion of the gases from the cell in the event of thermal runaway.

2. The device as claimed in claim 1, wherein the holding device has a frame which is fixed in relation to the cell and abutment means fixed to said frame.

3. The device as claimed in claim 2, wherein:
the gas releasing device has a plate, referred to as sealing plate, which has a through-hole,
the holding device has an abutment pad received in said hole in the sealing plate and configured to abut said second wall of the container, a channel being formed between said pad and the internal wall of said hole so as to form a passage for the gases,
the gas releasing device has closing off means arranged in said channel so as to close off said passage.

4. The device as claimed in claim 3, wherein the closing off means have a lip seal.

5. The device as claimed in claim 3, wherein the holding device has multiple abutment pads formed on one and the same common abutment plate fixed to said frame.

6. The device as claimed in claim 5, wherein said abutment plate has at least one through-opening.

7. The device as claimed in claim 2, wherein:
the holding device has an abutment plate arranged to ensure an abutment against said second wall of the container, and a compression plate fixed to the frame and arranged to compress said abutment plate, said abutment plate comprising a first through-hole and said compression plate comprising a second through-hole,
the gas releasing device has a perforable film arranged between said abutment plate and said compression plate, forming closing off means for the passage created by the first through-hole and by the second through-hole.

8. The device as claimed in claim 7, wherein the abutment plate has a recess for receiving a metal foil.

9. The device as claimed in claim 7, wherein said abutment plate has a receiving compartment for an electrochemical cell.

10. The device as claimed in claim 2, wherein the frame has a casing intended to accommodate said electrochemical cell.

11. The use of the safety device as defined in claim 1 for adaptation to an electrochemical cell of cylindrical format.

12. The use as claimed in claim 11, wherein the electrochemical cell is of the 18650 or 21700 format.
